(19) United States
(12) Patent Application Publication
(10) Pub. No.: US 2006/0197659 A1
(43) Pub. Date: Sep. 7, 2006

(54) Method and apparatus for conveying audio and/or visual material

(76) Inventor: Martyn Allen Farrows, Dublin (IE)

Correspondence Address: NOTARO AND MICHALOS, 100 DUTCH HILL ROAD, SUITE 110, ORANGEBURG, NY, 10962-2100, US

(21) Appl. No.: 11/367,989

(22) Filed: Mar. 3, 2006

(30) Foreign Application Priority Data
Mar. 4, 2005 (GB) 0504498.7

(51) Int. Cl. G08B 1/08

(52) U.S. Cl. 340/539.25

(57) ABSTRACT

A method and apparatus of conveying audio and/or visual material wherein at least one data object is associated with a respective part of the material, which at least one data object relates to additional information related to the respective part of the material and the method including displaying a temporally varying representation of the material, presenting at least one selectable link to the at least one data object in synchronisation with the progression of the material and the synchronisation being achieved at least in part by the at least one link having associated therewith data representative of the temporal position of the respective part in the material.

The present invention relates to a method and apparatus for conveying audio and/or visual material.

According to a first aspect of the invention there is provided a method of conveying audio and/or visual material wherein at least one data object is associated with a respective part of the material, which at least one data object relates to additional information related to the respective part of the material and the method comprising the steps of displaying a temporally varying representation of the material, presenting at least one selectable link to the at least one data object in synchronisation with the progression of the material and the synchronisation being achieved at least in part by the at least one link having associated therewith data representative of the temporal position of the respective part in the material.

The audio and/or visual material preferably temporally varies, or is arranged to temporally vary, in real-time.

The representation of the material may be considered as a temporally varying manifestation of the material.

Audio material preferably comprises speech (of one or more people), but may comprise music or any type of sound recording.

Where the material comprises speech the representation of the material comprises a transcript of the speech. However this need not necessarily be a word-for-word transcript for some or all of its length and at least part of the representation may comprise selected keywords or phrases from the speech. The speech may comprise a monologue, a dialogue (eg a conversation) or a debate.

Where the material comprises music or a sound recording of non-spoken audio then the representation may comprise a temporally varying narrative.

It is highly preferred where the representation is of audio material that the method comprises making available the opportunity for a user to play a sound recording of the material.

Visual material may comprise video, moving pictures, animation, film or evolving/varying graphics. The representation of the visual material may comprise a narrative to the temporally varying material.

Visual material may be of an essentially textual nature, for example a book, a document, a letter, a script, a commentary or instruction (for the purposes of training). Progression of the representation of such material may be accompanied by speech which reads aloud the text of the displayed representation.

It is highly preferred that a respective file or a respective part of a file allows the at least one link to be displayed in a synchronous manner relative to the material, and that the file comprises the data representative of the temporal position of that part of the material to which the link relates, and that if the at least one link is selected the corresponding data is retrieved from data storage means by reference to the temporal position data.

The at least one data object is preferably stored with direct reference to respective temporal position data, or at least an identifier which is associated with that data. In the latter possibility a look-up table may be employed which associates identifiers of data objects with respective temporal position data. In the former case the stored at least one data object is provided with the respective temporal position data so as to identify the same in case the object needs to be retrieved.

Preferably the representation of the material and the at least one link are provided as a Graphical User Interface (GUI).

The at least one link is preferably provided by a portion of text or a graphical object.

It is highly preferred that a plurality of links is provided and as the material evolves the links move through a viewing area. Preferably the links translate through the viewing area in a time-line representation. It is highly preferred that the viewing area provides a window on the time-line representation so that the links which are viewable will depend on the instantaneous temporal position of the material.

In an alternative embodiment however the links are displayed simultaneously (and may be substantially static) and that as the material evolves the respective links are sequentially highlighted as being available for selection.

The at least one data object may comprise one, all or a combination of text, pictures, graphics, video, film, photographs or audio.

According to a second aspect of the invention there is provide apparatus for conveying audio/visual material comprising data processor means, data storage means and display means, the data processor being configured to implement the method of the first aspect of the invention wherein, in use, the display means provides a Graphical User Interface (GUI) to allow a user to select one or more data objects.

According to a third aspect of the invention there is provided a machine-readable data carrier which, when run on a data processor, is operative to implement the method of the first aspect of the invention.

According to a fourth aspect of the invention there is provided a software product which, when loaded onto a data processor, is operative to implement the method of the first aspect of the invention.

According to a fifth aspect of the invention there is provided an authoring tool which allows the user to cause the method of the first aspect of the invention to be capable of being implemented in respect of chosen audio and/or visual material to be presented which is chosen by the user, and at least one associated data object which is chosen by the user.

A highly preferred embodiment of the invention may be viewed as an Interpreted Dialogue Builder And Player (IDBP). The IDBP provides an integrated platform that allows an author to create an interpreted dialogue, which can then be accessed by end users (students in directed education, staff engaged in professional development and life-long learners in a broader cultural context). The IDBP synchronises access to interpretative materials to the timeline of a dialogue and its transcript through the use of XML-based timestamp files. The IDBP combines backend functionality (the Builder) and sophisticated web-based interface (the Player). The Builder holds and manages the disparate types of interpretive material, arranged according to author (and user) defined themes, allowing authors to timestamp the material in relation to the dialogue. The Player supports authors in bringing the dialogue and interpretive content together, via synchronisation engine that exploits the timestamps, and thus provides the user learners with an engaging learning experience. The IDBP is in effect an aggregate learning object, capable of containing other learning objects as interpretive elements; as such the IDBP incorporates the functionality necessary for virtual tutoring and learner monitoring.

One embodiment of the invention will now be described, by way of example only, with reference to the following Figures in which:

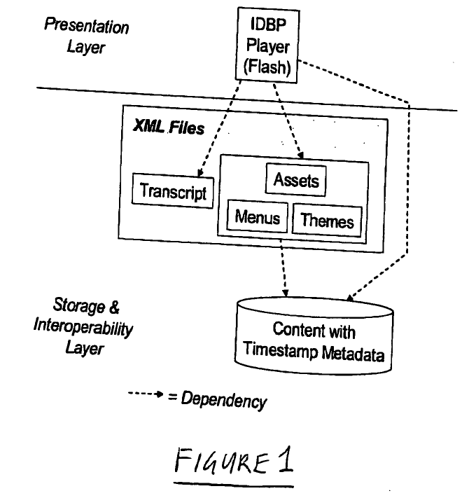

FIG. 1 is a schematic representation of the architecture of the player of an Interpreted Dialogue Builder And Player (IDBP),

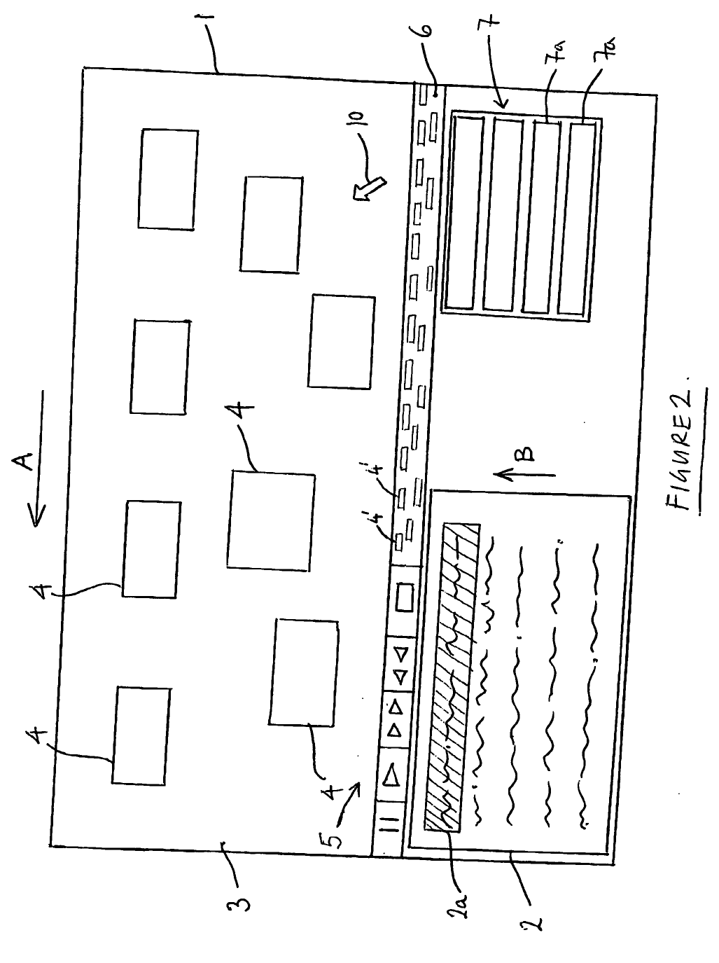

FIG. 2 is a schematic representation of a Graphical User Interface (GUI) of the player of FIG. 1,

FIG. 3 is a code listing of part of an XML manifest file of a dialogue transcript,

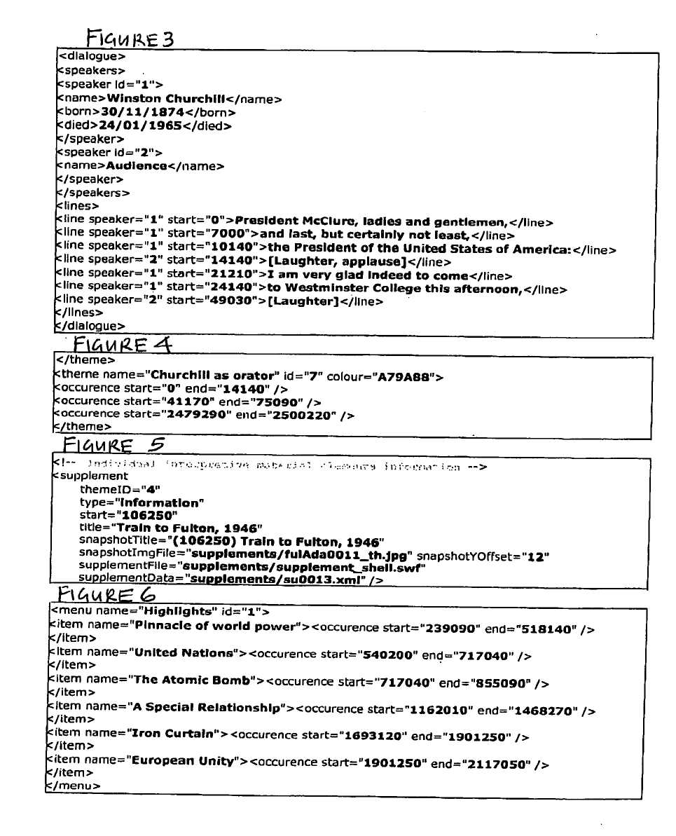

FIG. 4 is a code listing of part of an XML manifest file relating to themes,

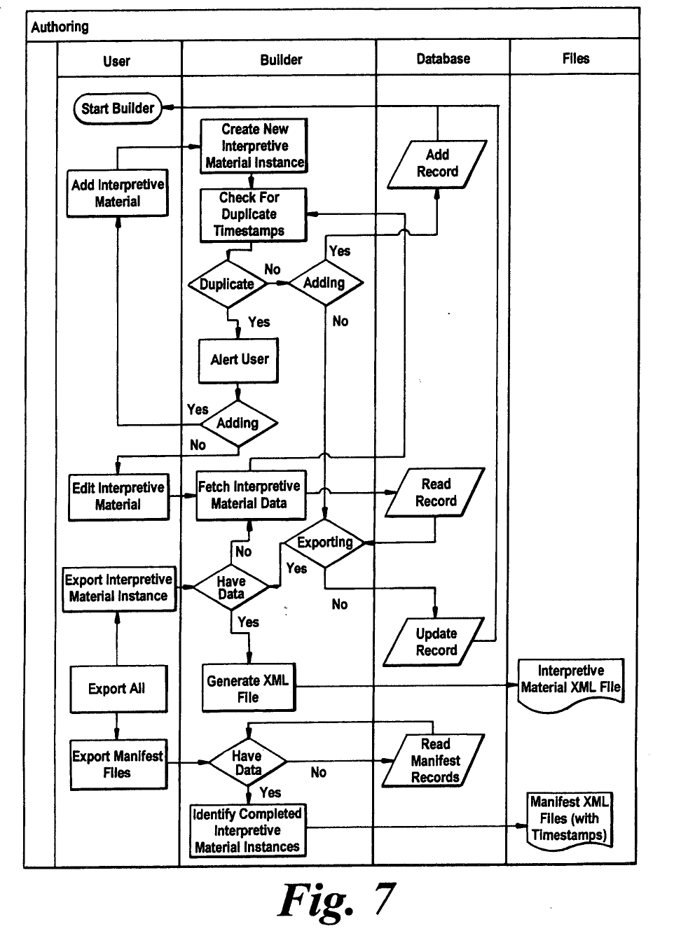

FIG. 5 is a code listing of part of an XML manifest file relating to assets,

FIG. 6 is a code listing of part of an XML manifest file relating to menus,

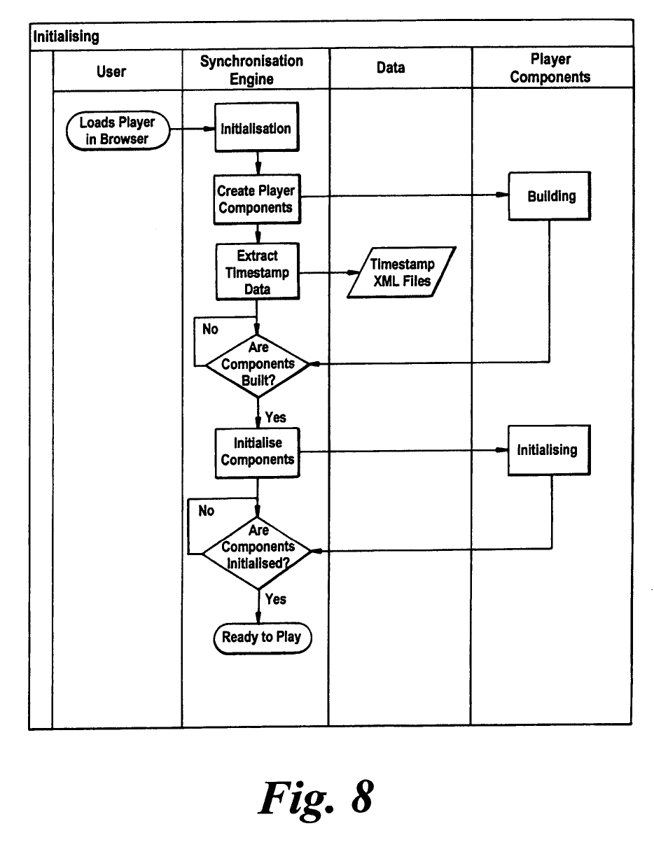

FIG. 7 is a flow chart of the IDBP in an authoring mode,

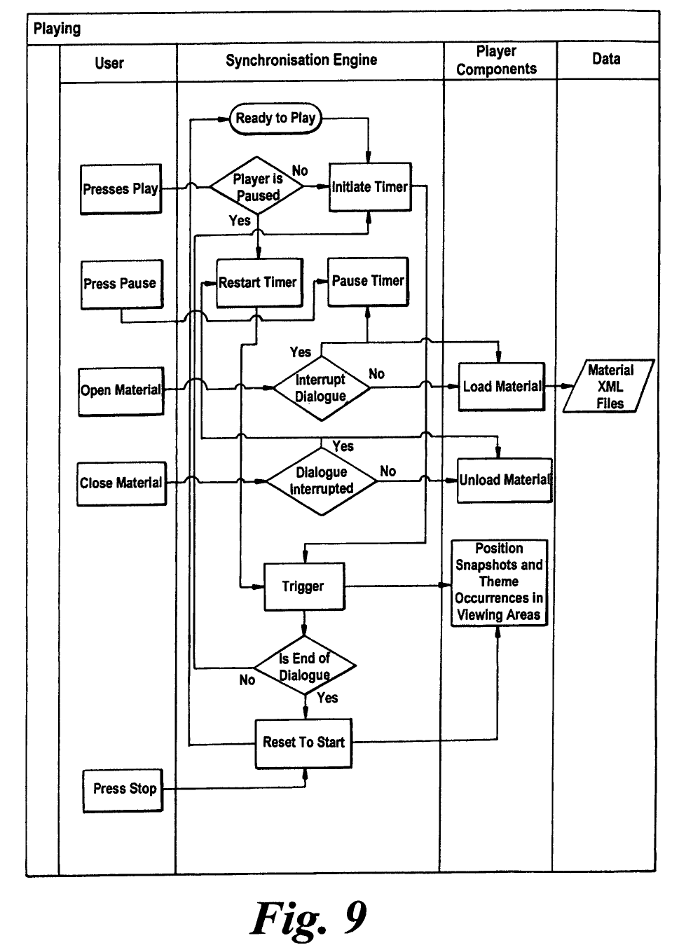

FIG. 8 is a flow chart of the IDBP in an initialising mode, and

FIG. 9 is a flow chart of the IDBP in a play mode.

FIG. 1 shows the architecture of a player of what may be termed an Interpreted Dialogue Builder And Player (IDBP) which is to be used with a data processor (not shown), for example a PC, data storage means (not shown), and user input means, for example a keyboard and/or a mouse. The player comprises a synchronisation engine which ensures that a dialogue being played (in an audio or video format) is kept in synchronisation with an on-screen presentation of both a text version of a dialogue, for example a speech, and links to a range of related support materials. The synchronisation engine ensures that the required temporal relationship between the material and the links to additional information is maintained.

The IDBP comprises a set of the following inter-connected layers:
1. A presentation layer provides access to the Player functionality and combines the use of component technology (developed in Flash ActionScript™) with XHTML, which pulls in files from a storage and interoperability layer as required. Access to the dialogue and the support material is supported for web browsers that are compliant with accessibility standards.
2. A storage and interoperability layer is based on MySQL database and PHP, and holds the source audio/video files, time-stamped XML manifest files and the support material. Extensive use is made of XML to maximise interoperability.
3. An authoring layer is in effect another presentation layer that allows authors to create new interpreted dialogue instances, providing the functionality of the Builder.

The ‘synchronisation engine’, which ensures that all interpretive elements and theme occurrences (ie the support material) are presented to the learner user at the correct time in relation to the point reached in the dialogue, uses a hierarchy of files that hold/use the timestamp data:
1. A top-level Flash file manages the overall operation of the Player and uses the subsidiary XML manifest files
2. A transcript XML file (for example the one shown in FIG. 3) contains the timestamp structure for the dialogue itself.
3. An assets XML file (for example the one shown in FIG. 5) holds the timestamp information for the interpretive material.
4. A themes XML file (for example the one shown in FIG. 4) holds the timestamps for the theme occurrences
5. A menus XML file (for example the one shown in FIG. 6) contains the timestamps for the highlights and dialogue sections.

The transcript timestamps are generated by manually portioning a pre-existing text file (ie a transcript of the speech) into dialogue fragments, uniquely identifying them and adding timestamp information from the corresponding audio/video file (derived using an application such as Adobe Audition™). Temporal conversion is usually necessary to convert the timestamp output into the millisecond resolution required for the Player synchronisation. The dialogue fragment data is automatically transformed into the transcript XML file.

The other XML files (assets, menus and themes) are created automatically from authored timestamp metadata for each item held in the storage and interoperability layer. Each item stored in the storage and interoperability layer is referenced using the timestamp data relating to when a link to the item is displayed, ie data representative of a time with respect to the timeline of the speech.

The player comprises a Graphical User Interface (GUI) which is schematically shown in FIG. 2. As is evident, a viewable area 1 of a viewing device is divided into various regions.

A first region 2 is provided which displays the transcript of audio material comprising speech.

A second region 3 is provided which displays various links to additional information (such as interpretive material or theme occurrences), the links being in the form of graphical objects 4 which may comprise text.

A third region 5 is provided which comprises various control ‘buttons’ which allow a user to control the evolution of the audio material and the presentation.

A fourth region 6 provides a smaller scale version of the objects 4 which, in the region 6, are displayed as objects 4′.

A fifth region 7 is provided which comprises buttons 7a which allow a user to access one or more data objects relating to additional information stored in the storage and interoperability layer.

In use, a user controls a cursor arrow 10 to select the PLAY button from the control buttons 5. This causes the synchronisation engine of the player to load and play an audio file of a sound recording of speech. Importantly, the synchronisation engine is further operative to display a transcript of the speech in the region 2. As the speech progresses, that part of the speech which is audible is highlighted in the region 2a, and the displayed text of the transcript moves in the direction indicated by arrow B.

As the speech progresses the various graphical objects 4 which provide links to data objects relating to additional material stored in the storage and interoperability layer, are displayed in a timeline sequence.

Importantly, this allows a user to use the cursor arrow 10 to select one or more of the graphical and/or textual objects 4 and so obtain the associated additional information related to an instantaneous part of the speech. During evolution of the speech the graphical objects 4 move across the region 3 in the direction of the arrow A.

The region 6 provides a thumbnail representation of the various links in time sequence which also, during playing of the speech, translates from right to left as the speech progresses.

The Builder will now be described in more detail.

A first step comprises pulling in the source audio or video file(s). The timestamp transcript file (in XML) is then created (as described above). As can be seen in FIG. 3, each part of the transcript has associated with it a number (following the text ‘start=’) which is the temporal position of that part relative to the audio file. This is the timestamp metadata.

A thematic structure for the dialogue or for a series of dialogues is then defined. FIG. 4 shows that the theme ‘CHURCHILL AS ORATOR’ has an occurrence that starts at time position 41170 and a later occurrence that ends at time position 75090, and later on starts at time position 2479290 and ends at 2500220.

Incorporating pre-existing interpretive elements. As shown in FIG. 5, a graphical link entitled ‘TRAIN TO FULTON 1946’ will be displayed from time position 106250. If a user clicks on the displayed graphical image link then the additional material is retrieved from the storage and interoperability layer with reference to the starting time position, by the synchronisation engine.

There are many advantages of the IDBP, some of which are provided below.

The player allows the learner to access the material as a whole or via individual sections. (The latter can be either author-defined or user-defined).

Learners can be supported in the use of the interpretive material in terms of real-time virtual tutoring.

Learners' use of the IDBP can be monitored at three levels:
1. Access to the dialogue, to its sections and to the supporting interpretive materials and embedded activities,
2. Completion of embedded activities,
3. Progress with an embedded activity.

Furthermore different levels of monitoring can be specified for individual elements of the material.

By creating an IMS manifest file, aggregating the educational metadata of embedded elements and learning objects, to support use of a dialogue instance from within learning management systems.

Providing additional metadata may be provided to facilitate access to a dialogue instance via Internet search engines.

Advantageously, the IDBP player makes it much easier than traditional resources for a learner to find out more information about a specific dialogue. The material is presented in a more holistic manner that engages the learner with different aspects of the dialogue. These aspects can include:
The origins of the dialogue
The ‘theatrical context’, ie the way in which the dialogue was or can be presented
The political, social, historical or artistic context in which the dialogue was or is delivered
Comparison of different versions of the dialogue
Comparison of various interpretations of the dialogue
Themes of particular relevance to the dialogue. (The themes may be specific to an individual dialogue or may span a series of dialogues to support comparative analysis).

The IDBP also supports two key pedagogic features:
Virtual tutoring that provides individual students with real-time support for appropriate embedded activities.
Learner accounts to allow student progress to be monitored and to facilitate tutor intervention if appropriate.

The IDBP comprises a combination of computer technologies that provides a more comprehensive and engaging multi-media learning experience.

Advantageously the IDBP provides a tagging methodology which manages the temporal relationship between the different elements of content which can take a variety of forms: audio clips, video clips, facsimiles of original material, other images, commentaries and analyses of aspects of the dialogue.

The IDBP generates an interface which makes it easy for the user to navigate to different parts of the dialogue, to access interpretive material and to return to the dialogue.

Layering of the interpretive material accommodates the needs of learners at different levels of knowledge and capability.

The IDBP provides the ability for a tutor, teacher, mentor or even a parent to monitor the progress of a learner remotely and intervene as required to assist the learner.

Access to the IDBP is preferably via a web browser. This allows remote access to permitted users via the Internet, a local area network, or a wide area network.

Provision may be made for support to interpretive dialogue authors.

The IDBP can be used in any context where a dialogue has been or can be captured in either audio or video format.

There are a wide range of school/educational uses, including:

Literature and drama studies

Legal studies

Media and broadcast studies

History (with an emphasis on speeches)

Political studies (with an emphasis on debates and speeches)

The IDBP can be used to support professional development with an emphasis on training in the use of dialogue-based operating procedures.

The IDBP has wide applicability in the cultural sector allowing interpretive treatment of archived audio and video files, including oral histories and curatorial commentaries.

The combination of the above features, together with the wealth of complementary elements that an author can readily harness to a specific dialogue instance, draws the learner into the material ensuring a deep learning that results in enhanced knowledge acquisition and retention.

1. A method of conveying audio and/or visual material wherein at least one data object is associated with a respective part of the material, which at least one data object relates to additional information related to the respective part of the material and the method comprising the steps of displaying a temporally varying representation of the material, presenting at least one selectable link to the at least one data object in synchronisation with the progression of the material and the synchronisation being achieved at least in part by the at least one link having associated therewith data representative of the temporal position of the respective part in the material.

2. A method as claimed in claim 1 wherein the audio and/or visual material temporally varies, or is arranged to temporally vary, in real-time.

3. A method as claimed in claim 1 wherein the audio material comprises speech.

4. A method as claimed in claim 3 in which the speech is speech of one or more people.

5. A method as claimed in claim 4 wherein the representation of the material comprises a transcript of the speech, at least part of the transcript comprising selected keywords or phrases from the speech.

6. A method as claimed in claim 1 wherein the audio material comprises music or a sound recording of non-spoken audio.

7. A method as claimed in claim 6 wherein the representation of the material comprises a temporally varying narrative.

8. A method as claimed in claim 1 wherein the method comprises making available the opportunity for a user to play a sound recording of the audio material.

9. A method as claimed in claim 1 wherein the visual material comprises video, moving pictures, animation, film or evolving/varying graphics.

10. A method as claimed in claim 1 wherein the representation of the visual material comprises a narrative to the temporally varying material.

11. A method as claimed in claim 1 wherein the visual material is of an essentially textual nature.

12. A method a claimed in claim 11 in which the material comprises at least one of a book, a document, a letter, a script, a commentary or instruction for the purposes of training.

13. A method as claimed in claim 11 wherein progression of the representation of such material is accompanied by speech which reads aloud the text of the displayed representation.

14. A method as claimed in claim 1 wherein a respective file or a respective part of a file allows the at least one link to be displayed in a synchronous manner relative to the material, and the file comprises the data representative of the temporal position of that part of the material to which the link relates, and if the at least one link is selected the corresponding data is retrieved from data storage means by reference to the temporal position data.

15. A method as claimed in claim 14 wherein the at least one data object is preferably stored with direct reference to respective temporal position data, or at least an identifier which is associated with that data.

16. A method as claimed in claim 1 wherein the at least one link is preferably provided by a portion of text or a graphical object.

17. A method as claimed in claim 1 wherein that a plurality of links is provided and as the material evolves the links move through a viewing area.

18. A method as claimed in claim 17 wherein the links translate through the viewing area in a time-line representation.

19. A method as claimed in claim 18 wherein the viewing area provides a window on the time-line representation so that the links which are viewable will depend on the instantaneous temporal position of the material.

20. A method as claimed in claim 1 wherein a plurality of links are displayed simultaneously and are substantially static and as the material evolves the respective links are sequentially highlighted as being available for selection.

21. A method as claimed in claim 1 wherein the at least one data object comprises one, all or a combination of text, pictures, graphics, video, film, photographs or audio.

22. A method as claimed in claim 1 wherein the representation of the material and the at least one link are provided as a Graphical User Interface (GUI).

23. Apparatus for conveying audio/visual material comprising data processor means, data storage means and display means, the data processor being configured to implement the method of claim 1 wherein, in use, the display means provides a Graphical User Interface (GUI) to allow a user to select one or more data objects.

24. A machine-readable data carrier which, when run on a data processor, is operative to implement the method of claim 1.

25. A software product which, when loaded onto a data processor, is operative to implement the method of claim 1.

26. An authoring tool which allows the user to cause the method of claim 1 to be capable of being implemented in respect of chosen audio and/or visual material to be presented which is chosen by the user, and at least one associated data object which is chosen by the user.
